(19) United States
(12) Patent Application Publication
(10) Pub. No.: US 2014/0324660 A1
(43) Pub. Date: Oct. 30, 2014

(54) METHOD OF CREATING STANDARDIZED BASKETS OF MEDICAL AND RECREATIONAL GRADE CANNABIS TO BE USED IN FINANCIAL AND COMMERCIAL TRADING PRODUCTS

(71) Applicants: Seth Adam Bolno, Rockville, MD (US); Christopher Dean Pilling, Healdsburg, CA (US)

(72) Inventors: Seth Adam Bolno, Rockville, MD (US); Christopher Dean Pilling, Healdsburg, CA (US)

(21) Appl. No.: 14/160,192

(22) Filed: Jan. 21, 2014

Related U.S. Application Data
(60) Provisional application No. 61/849,330, filed on Jan. 24, 2013.

(51) Int. Cl. G06Q 30/00

(52) U.S. Cl. CPC G06Q 30/018; G06Q 40/04
USPC 705/37; 800/298

(57) ABSTRACT

A process to create a fungible global investment grade standard for cannabis. The process involves grouping various strains in an investment grade standard according to their specific characteristics and minimum expectations. Cannabis that conforms to the investment grade standard is interchangeable within a specific range according to an equivalent monetary bundling process. Cannabis subjected to the standard conform to a specified set of requirements that enables it to be used to create baskets of cannabis to form an index/benchmark for cannabis pricing, financial instruments, and a global investment grade standard that can be used for certifying cannabis as investment grade to ensure top measures of quality, consistency, and liquid market pricing. All forms of medical and recreational cannabis are included within the scope of this standard.

### CROSS-REFERENCE TO RELATED APPLICATIONS

This application claims priority to U.S. Provisional Patent Application Ser. No. 61/849,330, filed Jan. 24, 2013, the entire disclosure of which is hereby expressly incorporated by reference herein.

### TECHNICAL FIELD

The present invention relates generally to a method of standardization for medical and recreational grade cannabis in order to enable the delivery of a standardized, fungible and certified global investment grade cannabis to be used in financial and commercial products. The value of the basket is tied to the value of the cannabis. The baskets are intended to offer investors a new and different opportunity to participate in the cannabis market through an investment in a regulated securities market. The logistics of buying and storing cannabis have constituted a barrier to entry for institutional and retail investors alike. The baskets are intended to overcome these barriers to entry. More particularly, the present invention relates to a standardized basket of cannabis used in financial products such as futures contracts, options, exchange traded funds (“ETF's”) or any other regulated or unregulated financial vehicle.

### BACKGROUND OF THE INVENTION

Cannabis is currently the largest cash crop produced in the United States, with estimates of annual production in the tens of billions of dollars per year. Evidence of early human cannabis use dates back to greater than 3,000 years ago. Major uses of the cannabis plant include medical, recreational and industrial. Medical benefits include diminished feelings of nausea and vomiting, appetite stimulation for chemotherapy and AIDS patients, lowered intraocular eye pressure for the treatment of glaucoma, as well as an effective pain reliever for a host of ailments. Cannabis may also be used for industrial purposes. Seeds provide natural oils as well as a nutritious source of high-protein, high-carbohydrate nourishment. Its stiff, fibrous stalk can be broken down to produce pulp for paper goods, as well as deriving fibers to weave into clothing, rope and ship sails. In addition, the natural cellulose contained in the bare trimmed stalk of the cannabis plant may be used to produce alcohol from its biomass to provide a petroleum free fuel source.

Similar to all other major agricultural industries such as corn, wheat, cotton and soybeans, cannabis is subject to a volatile range of price fluctuations. Among others, some factors which influence the market price are referred to here as the 4C's of Cannabis: Cannabinoids, Characteristics such as weight, moisture and strain, Color of trichomes, Contaminants, as well as general supply and demand characteristics. There is currently no industry benchmark for standardizing the mechanisms which affect daily prices of cannabis, and there is not a structured financial market either on an over-the-counter (OTC) or exchange-traded basis. The organizations involved in cultivation and distribution demand the benefit of reliable price hedging and may insist on gaining access to a liquid futures market to maintain a sustainable industry. This is where a specialized global cannabis index will be desired—to ultimately create a futures market based on the standardized basket of cannabis as the deliverable. In addition, the standardized index may be used in the creation of options contracts, swaps, exchange traded funds (“ETF's”) and mutual funds.

This invention is an index of specifically defined cannabis characteristics that will be representative of a global standard for cannabis pricing. Thus, a properly groomed cannabis deliverable with limited traces of contaminants, whose color meets specific measurable characteristics, contains cannabinoids testing high in THC & CBD while containing minimal levels of CBN, are all candidates of the investment grade standard. Deviations of characteristics defined outside the confines of the 4C's may be subject to premium or discounted pricing schedules per basket. Depending on the purchaser, each individual load of cannabis may be accompanied by a price adjustment determined by the confines of the 4C's of Cannabis method following sufficient examination.

### BRIEF SUMMARY OF THE INVENTION

Accordingly, it is an object of the present invention to provide a method of standardization of cannabis. It is a particular objective of the present invention to provide a method of standardization of cannabis in order to enable the delivery of standardized, fungible and certified global investment grade cannabis to be used in financial and commercial products. To attain this, the present invention essentially comprises a process in which the cannabis selected for use in a standardized collection must meet a minimum standard. The standard would require that all the cannabis to be included in the standardized collection must be evaluated and identified by its classifications. These include: Cannabinoids, Characteristics, Color, and Contaminants.

Yet another object of the present invention is to provide a standardized basket of cannabis used in financial products such as futures contracts, options, exchange traded funds (“ETF's”) or any other regulated or unregulated financial vehicle. Regarding the exchange-traded funds, the basket of cannabis is deposited with one or more custodians in exchange for a creation unit. The creation unit represents a plurality of shares of the Fund. In the preferred embodiment the number of shares in the creation unit is 25,000 shares. The number of shares of the creation unit can be selected to be any number, and may be selected to be more or less than 25,000 depending on the value of the creation unit and the target price range at which an individual share is expected to be sold.

### BRIEF DESCRIPTION OF THE DRAWINGS

FIG. 1. is a chart that defines the complete list of discount, par, and premium values for THC, CBD, and CBN in a standardized basket of cannabis.

FIG. 2. is a chart that defines the clear, milky, and amber trichome color category according to the RGB color scale.

### DETAILED DESCRIPTION OF THE INVENTION

In accordance with the present invention, a preferred exemplary embodiment of the method for creating a standardized basket of cannabis flowers is described below, hereinafter “cannabis flowers” may also be denoted as “cannabis”. The standardized cannabis collection of the present invention which may be used in any financial instrument is created using botany and visual standards as well as market factors to identify appropriate cannabis for inclusion in the standardized basket in the following manner. It should be understood that variations in the creation of the standardized basket may be used, such as for example, the amount of cannabis, and the value of comparable cannabis may be adjusted and still fall within the spirit and scope of the invention.

Initially, the cannabis selected for use in a standardized collection must meet a minimum standard. The standard would require that every single cannabis flower that can be included in the standardized collection must eventually conform to the following identification requirements:

All cannabis must be evaluated and identified by its classifications. These include:

### 1. Cannabinoids,

### 2. Characteristics,

### 3. Color,

### 4. Contaminants.

Requirements for cannabis that will be part of the standardized basket of cannabis and may be used in financial instruments must meet the following criteria:

Cannabinoids: The cannabis must meet minimum standards of THC, CBD, and CBN, determined by gas and/or liquid chromatography as follows: THC>10% and >15%, CBD>0% and >0%, and CBN 0.5% and 1% for gas and liquid chromatography respectively.

Characteristics: The cannabis must meet standards of strain variety and moisture %. Only Indica or Sativa dominant strains accepted; no afghan or ruderalis. Moisture content must be tested within the range of 3 to 8% to be accepted.

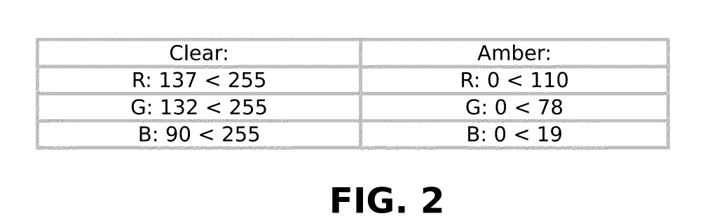

Color: The cannabis trichome color must meet the following criteria: According to the RGB color scale, average trichome clarity throughout the overall sample must not contain more than 50% exposure to either clear or amber color category, as defined therein in FIG. 2.

Contaminants: Each basket of deliverable cannabis must not include the following contaminants: Bacteria, fungus, yeast, molds, viruses, parasites, pesticides, herbicides, insecticides, bug parts, metal, plastic, soil, wood, and must meet all USDA, FDA and EPA guidelines, in addition to the health and safety guidelines of any other relevant organizations, where applicable, for the aforementioned items.

Once the cannabis that may be used in the standardized basket have been culled using the above identified standards, all of the cannabis will also be subject to the following storage requirements: Cannabis must be stored in acceptable packaging and kept in a cool, dark, air tight environment. Preferably, the cannabis basket should be stored into sealed mylar packages injected with nitrogen to reduce degradation and discoloring, as well as to prevent mold and bacteria growth from forming.

It is preferred but not necessary that all cannabis must be obtained from certified or approved vendors, where applicable.

All cannabis supplied by all vendors must go through rigorous quality control inspections to insure that all requirements identified above have been met. In addition, it may be required that a certification agent, or similar qualified professional will be called upon to ensure minimum standards have been met. Upon satisfactory approval in the preferred embodiment, all cannabis packaging may be inscribed “trading approved” or similar logo along with an identification serial number for authentication purposes. Then they can be released to the market for trading purposes. It should be understood that while inscription is preferred, it is not necessary in order to be within the spirit and scope of the described invention.

While the cannabis that meets the requirements above are all capable of being used in a standardized basket, in the preferred embodiment of the present invention, the selection of cannabis is limited further. An example of how the cannabis can be limited further due to market factors is explained below.

The primary objective is to achieve the maximum degree of fungibility that is acceptable for commercial commodity and financial trading of cannabis and requires the minimum effort for global cannabis manufacturers to supply.

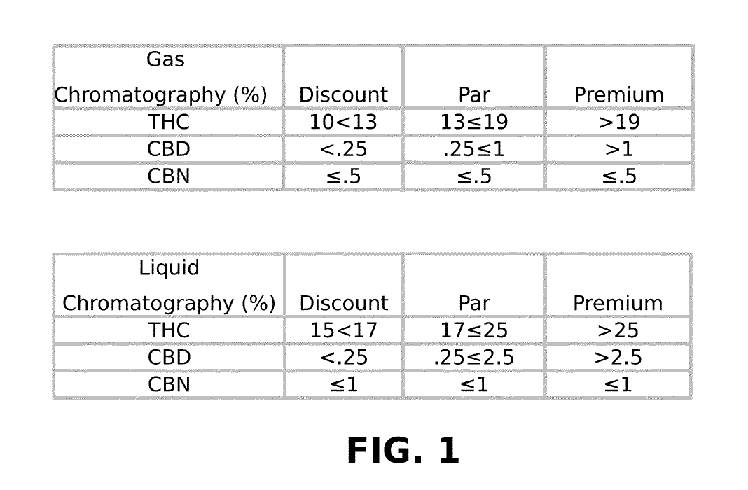

The first criterion considered in creating the exemplary standardized basket was Cannabinoids. Although the minimum standards of cannabis THC, CBD, and CBN listed above are acceptable, preferably, the par value determined by gas chromatography should be as follows: THC of 13%≦0.19%, CBD of 0.25%≦1%, and a CBN of ≦0.5%. Likewise, the par value determined by liquid chromatography should be as follows: THC of 17%≦25%, CBD of. 25%≦2.5%, and a CBN of ≦1%. The complete list of discount, par, and premium values for THC, CBD, and CBN are defined in FIG. 1.

The second criterion considered in creating the exemplary standardized basket was characteristics. In regards to cannabis size, cannabis smaller than 0.5″ diameter has a perception as being too small to be Investable Grade and more difficult to manage. A specialized 0.5″ diameter mesh sifting basket is used to isolate the smaller cannabis sized flowers, as well as any excess cannabis plant matter and other debris.

The third criterion used in creating the exemplary standardized basket was color. Preferably, the average trichome clarity throughout the overall sample should not contain more than 20% exposure to either clear or amber color category, as defined therein in FIG. 2, according to the RGB color scale.

Today, cannabis values are set according to its 4C's. Specifically the value is determined by the Cannabinoids, assuming the cannabis meets the minimum standards of Characteristics, Color, and Containments. If the values of THC, CBD, and CBN fall in the range of discount as seen in FIG. 1, the entire basket value will be considered discount. Likewise, if the values of THC, CBD, and CBN fall in the range of the par as seen in FIG. 1, the entire basket value will be considered par. Furthermore, if the values of THC, CBD, and CBN fall in the range of premium as seen in FIG. 1, the entire basket value will be considered premium.

It is expected that the total weight of each Basket will be a minimum of 1 pound or 454 grams. It should be understood that different classifications of cannabis and weight may be used to create Baskets that are within the spirit and scope of the described invention.

It should be understood that futures and options contracts based on the standardized cannabis basket made in accordance with the methods described above are part of the invention. It should be understood that the ETF may also be structured based on the futures contracts. Futures on the cannabis Baskets may be traded on exchanges such as the Chicago Mercantile Exchange (“CME”). Likewise, options for standardized cannabis Baskets may be traded, for example, on the Chicago Board of Option Exchange (“CBOE”).

In another embodiment of the present invention, the standardized basket of cannabis may be used to create an Exchange Traded Fund (“ETF”). It is expected that the standardized basket of cannabis can be used to create an Exchange Traded Fund based on the basket of cannabis.

It should be understood that other baskets can be created using greater or lesser Standardized Classes as described above. While the invention has been described and illustrated with reference to specific embodiments, those skilled in the art will recognize that modifications and variations may be made without departing from the principles of the invention as described hereinabove and set forth in the following claims.

We claim:

1. A method to create fungible global investment grade standard for cannabis comprising:
a basket of cannabis including a plurality of cannabis flowers, wherein said cannabis flowers must meet a minimum standard.

2. The method of claim 1 wherein said minimum standard comprises identification requirements, wherein said cannabis flowers must conform to said identification requirements.

3. The method of claim 2 wherein said identification requirements comprises a cannabinoids classification, a characteristics classification, a color classification, and a contaminants classification.

4. The method of claim 3 wherein said cannabinoids classification comprises a requirement defined by a tetrahydrocannabinol (THC) level, a cannabidiol (CBD) level, and a cannabinol (CBN) level, wherein said level is a percentage.

5. The method of claim 4 wherein said requirement must meet a minimum standard.

6. The method of claim 5 wherein said minimum standard is determined by a gas and a liquid chromatography certificate of analysis, defined as a THC level>10% and >15%, a CBD level>0% and >0%, and a CBN level≦0.5% and ≦1% for gas and liquid chromatography respectively.

7. The method of claim 4 wherein said requirement includes a discount value, a par value, and a premium value.

8. The method of claim 7 wherein said discount value determined by a gas chromatography certificate of analysis, defined as a THC level of 10%<13%, a CBD level of <0.25%, and a CBN level of ≦0.5%; said par value is defined as a THC level of 13%≦19%, a CBD level of 0.25%≦1%, and a CBN level of ≦0.5% for gas chromatography; said premium value is defined as a THC level of >19%, a CBD level of >1%, and a CBN level of ≦0.5% for gas chromatography.

9. The method of claim 7 wherein said discount value determined by a liquid chromatography certificate of analysis, defined as a THC level of 15%<17%, a CBD level of <0.25%, and a CBN level of ≦1%; said par value is defined as a THC level of 17%≦25%, a CBD level of 0.25%≦2.5%, and a CBN level of ≦1% for liquid chromatography; said premium value is defined as a THC level of >25%, a CBD level of >2.5%, and a CBN level of ≦1% for liquid chromatography.

10. The method of claim 3 wherein said characteristics classification comprises a standard of strain variety, a standard of cannabis flower size, and a predetermined moisture level; said moisture level must be within a range of 3 to 8% to be accepted.

11. The method of claim 10 wherein said standard of strain variety is preferably Indica or Sativa dominant strains, no afghan or ruderalis.

12. The method of claim 10 wherein said cannabis flower size is larger than 0.5″ in diameter; wherein said basket of cannabis will be a minimum of 1 pound of total weight.

13. The method of claim 3 wherein said color classification comprises a standard criteria of trichome clarity; said trichome clarity must not contain more than 50% exposure to either clear or amber color, preferably said trichome clarity should not contain more than 20% exposure to either clear or amber color.

14. The method of claim 3 wherein said contaminants classification comprises a standard criteria in which said basket of cannabis must not include the following contaminants: bacteria, fungus, yeast, molds, viruses, parasites, pesticides, herbicides, insecticides, bug parts, metal, plastic, soil, wood, and must meet all USDA, FDA and EPA guidelines, in addition to the health and safety guidelines of any other relevant organizations, where applicable, for the aforementioned items.

15. A method of creating standardized baskets of medical and recreational investment grade cannabis to be used in financial and commercial trading products comprising: an index of specifically defined cannabis characteristics that will be representative of a global investment grade standard for cannabis pricing, wherein said index may be used in the creation of futures contracts, options contracts, swaps, exchange traded funds, and mutual funds.

16. The method of claim 15 wherein said cannabis characteristics include a cannabinoids classification, a characteristics classification, a color classification, and a contaminants classification.

17. The method of claim 16 wherein said cannabinoids classification comprises a requirement defined by a tetrahydrocannabinol (THC) level, a cannabidiol (CBD) level, and a cannabinol (CBN) level, wherein said level is a percentage; wherein said requirement must meet a minimum standard.

18. The method of claim 16 wherein said characteristic classification comprises a standard of strain variety, a standard of cannabis flower size, and a predetermined moisture level; said moisture level must be within a range of 3 to 8% to be accepted; wherein said standard of strain variety is preferably Indica or Sativa dominant strains, no afghan or ruderalis; wherein said cannabis flower size is larger than 0.5″ in diameter; wherein said basket of cannabis will be a minimum of 1 pound of total weight.

19. The method of claim 16 wherein said color classification comprises a standard criteria of trichome clarity; said trichome clarity must not contain more than 50% exposure to either clear or amber color, preferably said trichome clarity should not contain more than 20% exposure to either clear or amber color; wherein said contaminants classification comprises a standard criteria in which said basket of cannabis must not include the following contaminants: bacteria, fungus, yeast, molds, viruses, parasites, pesticides, herbicides, insecticides, bug parts, metal, plastic, soil, wood, and must meet all USDA, FDA and EPA guidelines, in addition to the health and safety guidelines of any other relevant organizations, where applicable, for the aforementioned items.

20. A method to create fungible global investment grade standard for cannabis comprising:
a basket of cannabis including a plurality of cannabis flowers, wherein said cannabis flowers must meet a minimum standard; wherein said minimum standard comprises identification requirements, wherein said cannabis flowers must conform to said identification requirements; wherein said identification requirements comprises including a cannabinoids classification, a characteristics classification, a color classification, and a contaminants classification; wherein said cannabinoids classification comprises a requirement defined by a tetrahydrocannabinol (THC) level, a cannabidiol (CBD) level, and a cannabinol (CBN) level, wherein said level is a percentage; wherein said requirement must meet a minimum standard; wherein said characteristic classification comprises a standard of strain variety, a standard of cannabis flower size, and a predetermined moisture level; wherein said color classification comprises a standard criteria of trichome clarity; wherein said contaminants classification comprises a standard criteria in which said basket of cannabis must not include contaminants including but not limiting to bacteria, fungus, yeast, molds, viruses, parasites, pesticides, herbicides, insecticides, bug parts, metal, plastic, soil, and wood.
